(19) United States
(12) Patent Application Publication
(10) Pub. No.: US 2025/0124683 A1
(43) Pub. Date: Apr. 17, 2025

(54) TRAFFIC DRIVER ASSISTANCE DEVICE USING AI AMBIDIRECTIONAL CAMERA

(71) Applicant: BLUESIGNAL INC, Daejeon (KR)

(72) Inventor: Seung-Tae BACK, Daejeon (KR)

(73) Assignee: BLUESIGNAL INC, Daejeon (KR)

(21) Appl. No.: 18/894,288

(22) Filed: Sep. 24, 2024

(30) Foreign Application Priority Data
Oct. 11, 2023 (KR) 10-2023-0135336

(51) Int. Cl. G06V 10/12; B60Q 9/00; B61L 23/04; G06V 10/70; G06V 10/764; G06V 10/774; G06V 20/56; G06V 20/59; H04N 23/695

(52) U.S. Cl. CPC G06V 10/12; B60Q 9/008; B61L 23/041; B61L 23/042; G06V 10/764; G06V 10/774; G06V 10/87; G06V 20/588; G06V 20/597; H04N 23/695

(57) ABSTRACT

A mobile driver assistance device with an AI bidirectional camera is provided. The mobile driver assistance device includes a body part, a front camera installed such that an image capturing lens is exposed to the front of the body part, to capture a driver, a rear camera installed such that an image capturing lens is exposed to the rear of the body part, to capture a traveling direction of the vehicle, a processor installed inside the body part and configured to determine, by using an AI model, a behavior of the driver and a condition of a road or a track in front of the vehicle based on images transmitted from the front camera and the rear camera, a memory installed inside the body part and storing the AI model, and an alarm unit configured to provide an alarm to the driver according to the determination of the AI model.

### CROSS-REFERENCE TO RELATED APPLICATIONS

This application claims priority to Korean Patent Application No. 10-2023-0135336 filed on Oct. 11, 2023, the entire contents of which are herein incorporated by reference.

### TECHNICAL FIELD

The present disclosure relates to a mobile driver assistance device that may be easily installable on transportation vehicles such as passenger cars, trucks, locomotives, trains, or trams, and more particularly, to a mobile driver assistance device capable of recognizing a forward condition of a vehicle, such as a predicted collision risk or a change in a track, and recognition of an obstacle, and a state of a driver, and providing an alarm to the driver based on the recognized condition and state, by using a bidirectional camera and an artificial intelligence (AI) model.

### BACKGROUND ART

Korean Patent Application No. 10-2021-0052634 (artificial intelligence (AI) device determining carelessness of driver and method thereof) discloses an AI device determining the carelessness of a driver including a vibration sensor or a gyro sensor that detects the movement of a driver seat of a vehicle, a camera that receives image data including the driver's face, a communication unit that receives vehicle condition information from an electronic control unit (ECU) of the vehicle, and a processor that generates movement information of the driver seat by using vibration sensor information received from the vibration sensor or gyro sensor information received from the gyro sensor, generates driver condition information corresponding to the driver from the received image data, determines whether the driver is in a careless state based on the movement information of the driver seat, the driver state information, and the vehicle condition information, and outputs an alarm for carelessness when the driver is in the careless state.

### DISCLOSURE

### Technical Problem

The present disclosure is directed to providing a mobile driver assistance device with an artificial intelligence (AI) bidirectional camera, which may be easily installed and used by a driver in a transportation vehicle such as a passenger car, a truck, a locomotive, train, or a tram.

### Technical Solution

According to an embodiment of the present disclosure, there is provided a mobile driver assistance device with an artificial intelligence (AI) bidirectional camera installed on a vehicle including a body part, a front camera installed such that an image capturing lens is exposed to the front of the body part, to capture a driver, a rear camera installed such that an image capturing lens is exposed to the rear of the body part, to capture a traveling direction of the vehicle, a processor installed inside the body part and configured to determine, by using an AI model, a behavior of the driver and a condition of a road or a track in front of the vehicle based on images transmitted from the front camera and the rear camera, a memory installed inside the body part and storing the AI model, and an alarm unit configured to provide an alarm to the driver according to the determination of the AI model.

The alarm unit may include at least one of a display and a speaker installed on the body part and configured to output sound.

The mobile driver assistance device may further include an angle adjustment button installed to be exposed on the body part and configured to adjust a direction of the front camera or the rear camera.

The mobile driver assistance device may further include a handle fixed to a side surface or an upper portion of the body part, and a support fixing means configured to support or fix the body part to the vehicle.

A sliding body may be provided in an upper front side of the body part, the front camera may be located in a front middle portion of the body part, the front camera when not in use may be covered by the sliding body in a descending state, and the rear camera may be formed at a rear of the sliding body and exposed for use by the sliding body in an ascending state.

The AI model may classify driver behavior patterns based on a driver image provided by the front camera, recognize the condition of the track or the road of the vehicle from the image provided by the rear camera, determine whether a pattern of the behavior of the driver is appropriate with reference to condition information of the track or the road acquired from the rear camera, and issue an alarm through the alarm unit when it is determined that the pattern is inappropriate.

The AI model may pretrain image data as training data with respect to at least one of traffic light related information, shape information of the track or the road, platform related information, and a collision prediction of a pedestrian or the vehicle so as to recognize the condition on the track or the road.

When the AI model recognizes a condition of the track in which the vehicle travels changing from a single track to a double branch track, a road branch condition, or an obstacle on the road or the track, and determines that the pattern of the behavior of the driver does not correspond to a preparatory behavior for track branch or a behavior to cope with the obstacle, the alarm unit may provide an alarm to the driver.

The processor may receive driving condition information of the vehicle from a control device of the vehicle, and the AI model may classify driver behavior patterns based on a driver image provided by the front camera, recognize a condition of a vehicle track or the road from the image provided by the rear camera, determine whether a pattern of the behavior of the driver is appropriate based on the driving condition information of the vehicle and condition information of the track or the road, and issue an alarm through the alarm unit when it is determined that the pattern is inappropriate.

The mobile driver assistance device may further include a user interface capable of receiving a type of the vehicle from the driver, and the processor may select the AI model based on the type of the vehicle.

The processor may determine a type of vehicle based on the image captured by the front camera or the rear camera, and select the AI model based on the determined type of vehicle.

### Advantageous Effects

The mobile driver assistance device with an artificial intelligence (AI) bidirectional camera according to an embodiment of the present disclosure may provide an alarm to a driver according to a change in a track in front of the vehicle and recognition of an obstacle or a predicted collision risk condition on the road by using the bidirectional camera.

In addition, the front camera, the rear camera, and the alarm unit are installed on one body part, and thus, the mobile driver assistance device with the AI bidirectional camera enables miniaturization, thereby facilitating portability and installation.

### DESCRIPTION OF DRAWINGS

FIG. 1 is a block diagram illustrating a configuration of a mobile driver assistance device with an artificial intelligence (AI) bidirectional camera according to an embodiment of the present disclosure.

FIG. 2 is a diagram illustrating an appearance of the mobile driver assistance device with the AI bidirectional camera according to an embodiment of the present disclosure.

FIG. 3 is a diagram for explaining a performing process of an AI model in the mobile driver assistance device with the AI bidirectional camera according to an embodiment of the present disclosure.

FIG. 4 is a flowchart illustrating a performing process of the AI model according to an embodiment of the present disclosure.

FIG. 5 is a diagram illustrating a front surface and side surfaces of a mobile driver assistance device with an AI bidirectional camera according to another embodiment of the present disclosure.

FIG. 6 is a perspective view of the mobile driver assistance device with the AI bidirectional camera according to another embodiment of the present disclosure.

### MODE FOR INVENTION

Hereinafter, embodiments of the present disclosure will be described in detail with reference to the accompanying drawings such that one of ordinary skill in the art may easily practice the embodiments. However, the present disclosure may be implemented in different ways and is not limited to the embodiments described herein. And, in order to clearly explain the embodiment of the present disclosure in the drawings, parts that are not related to the description are omitted.

The terms used herein are only used to describe specific embodiments, and are not intended to limit the present disclosure. A singular expression may include a plural expression, unless the context clearly indicates otherwise.

In the present specification, it should be understood that the terms such as “comprises”, “have” or “include” are merely intended to indicate that features, numbers, steps, operations, components, parts, or combinations thereof are present, and are not intended to exclude the possibility that one or more other features, numbers, steps, operations, components, parts, or combinations thereof will be present or added.

In addition, components described in the embodiments of the present disclosure are independently shown in order to indicate different characteristic functions, but this does not mean that each of the components includes a separate hardware or software component. That is, the components are arranged and included separately for convenience of description, and at least two of the components may be integrated into a single component or one component may be divided into a plurality of components to perform functions. An embodiment into which the components are integrated or an embodiment in which some components are separated is included in the scope of the present disclosure as long as it does not depart from the essence of the present disclosure.

Hereinafter, with reference to the attached drawings, a preferred embodiment according to the present disclosure will be described.

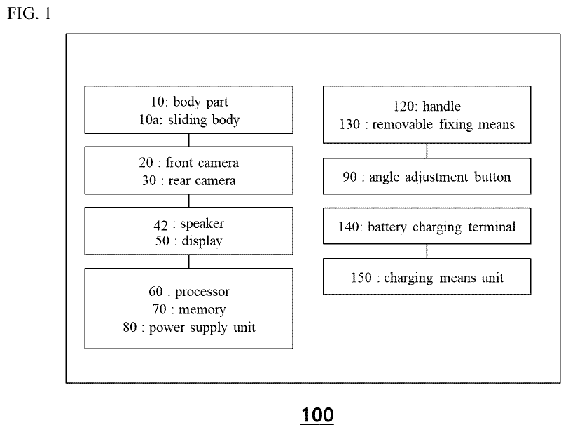

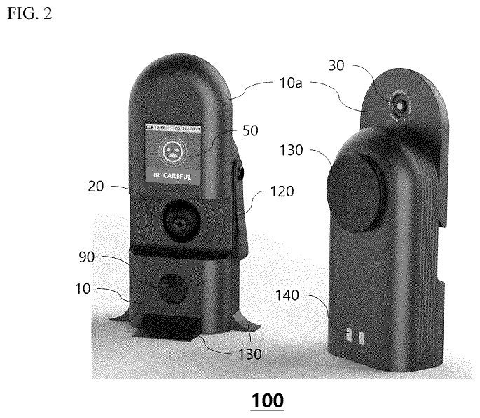

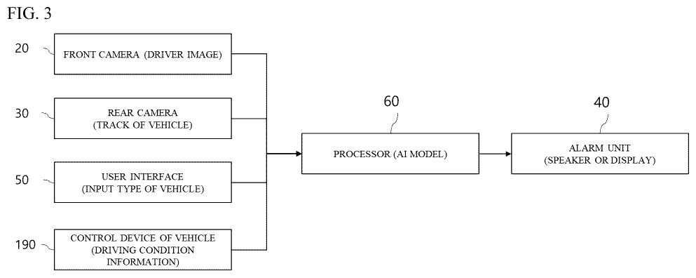

FIG. 1 is a block diagram illustrating a configuration of a mobile driver assistance device with an artificial intelligence (AI) bidirectional camera according to an embodiment of the present disclosure. FIG. 2 is a diagram illustrating an appearance of the mobile driver assistance device with the AI bidirectional camera according to an embodiment of the present disclosure. FIG. 3 is a diagram for explaining a performing process of an AI model in the mobile driver assistance device with the AI bidirectional camera according to an embodiment of the present disclosure.

In the following embodiment, the term “vehicle” means various types of moving objects that may be operable by a driver on board, such as a passenger car, a truck, a locomotive, train, or a tram.

Referring to FIGS. 1 to 3, a mobile driver assistance device 100 with the AI bidirectional camera according to an embodiment of the present disclosure may include a body part 10, a front camera 20, a rear camera 30, an alarm unit 40, a processor 60, a memory 70, and a power supply unit 80.

The body part 10 may be made of, for example, a plastic material, and main components of the present device, such as the front camera 20, the rear camera 30, the processor 60, and the memory 70, may be installed on the body part 10.

The front camera 20 may be installed such that an image capturing lens is exposed to the front of the body part 10 (in a direction looking at a driver). The processor 60 may perform image processing on an image capture by the front camera 20.

The rear camera 30 may be installed such that an image capturing lens is exposed to the rear of the body part 10 (a traveling direction of a passenger car or a train). The processor 60 may process an image captured by the rear camera 30.

The alarm unit 40 may be, for example, in the form of a speaker, and may be installed on the body part 10 and output sound. The alarm unit 40 may output voice and sound output from the processor 60.

A display 50 may be installed on a front surface of the body part 10, or may be installed in front of an elevating sliding body 10a supported by the body part 10 (in a direction toward the driver). The display 50 may be provided, for example, in the form of a user interface, and may receive information about the vehicle from the driver. For example, the driver may input whether the vehicle the driver is driving is a passenger car or a train through the display 50 that is the user interface. In addition, the display 50 may function as an alarm unit to visually provide an alarm to a user.

The processor 60 may be installed inside the body part 10 to determine a behavior of the driver and a condition of the road or train track in front of the vehicle, such as a change in a track and recognition of an obstacle or a predicted collision risk condition on the road, based on images transmitted from the front camera 20 and the rear camera 30 by using the AI model.

The memory 70 may be installed inside the body part 10 and store a program processed by the processor 60 and the AI model. The power supply unit 80 may be provided on an outer surface of the body part 10 to supply power to the processor 60, the display 50, the alarm unit 40, etc.

The front camera 20, the rear camera 30, the alarm unit 40, the display 50, the processor 60, and the memory 70 are installed on one movable and portable body part 10, and thus, the mobile driver assistance device 100 with the AI bidirectional camera according to an embodiment of the present disclosure enables miniaturization, thereby facilitating portability and installation by the driver in front of the vehicle or the train.

In addition, the mobile driver assistance device 100 with the AI bidirectional camera according to an embodiment of the present disclosure may provide an alarm to the driver according to a change in a track and recognition of an obstacle or a predicted collision risk condition on the road in front of the vehicle by using the bidirectional camera.

Hereinafter, a detailed configuration of the mobile driver assistance device 100 with the AI bidirectional camera according to an embodiment of the present disclosure will be described in more detail.

Referring to FIGS. 1 and 2, the mobile driver assistance device 100 with the AI bidirectional camera according to an embodiment of the present disclosure may further include an angle adjustment button 90 installed to be exposed on the body part 10 and adjusting directions of the front camera 20 and the rear camera 30. For example, as shown, the angle adjustment button 90 may be in a form capable of inputting a button in four directions, and may be provided as one to adjust the directions of the front camera 20 and the rear camera 30. Angle adjustment buttons for the front camera 20 and the rear camera 30 may be separately provided.

The mobile driver assistance device 100 with the AI bidirectional camera according to an embodiment of the present disclosure may further include a handle 120 fixed to a side surface or an upper portion of the body part 10, and a support fixing means 130 for supporting or fixing the body part 10 to the vehicle (a passenger car or a train).

In addition, the mobile driver assistance device 100 with the AI bidirectional camera according to an embodiment may further include a battery charging terminal 140 installed to be exposed to the body part 10 to charge the power supply unit 80 (when the power supply unit is a battery), and a charging means unit 150 formed separately from the body part 10 to supply power to the battery charging terminal 140.

As shown in FIGS. 1 and 2, the mobile driver assistance device 100 with the AI bidirectional camera according to the present disclosure may further include a sliding body 10a formed in the upper front side of the body part 10. For example, the front camera 20 may be located in the front middle portion of the body part 10, and may be covered by the sliding body 10a in a descending state when the front camera 20 is not used. The rear camera 30 may be formed at the rear of the sliding body 10a and may be exposed for use by the sliding body 10a in an ascending state.

Referring to FIGS. 1 to 3, the AI model of the mobile driver assistance device 100 with the AI bidirectional camera according to an embodiment of the present disclosure may classify driver behavior patterns based on a driver image provided by the front camera 20 and recognize the condition of the train track from the image provided by the rear camera 30. The AI model may determine whether a pattern of the driver behavior is appropriate, for example, in the event of a change in the track and recognition of an obstacle, or a predicted collision risk on the road with reference to the road (when the vehicle is a passenger car or a truck) and the track (when the vehicle is a train) condition information acquired from the rear camera 30, and may issue an alarm through a speaker 42 or the display 50 when it is determined that the pattern is inappropriate.

The AI model of the mobile driver assistance device 100 with the AI bidirectional camera according to an embodiment of the present disclosure may pretrain image data as training data with respect to at least one of traffic light related information (a shape of a traffic light, a color of the traffic light (red, blue, etc.)), shape information of the track or the road (a single track, a double branch track, etc.), and platform related information so as to recognize the change in the track and recognition of the obstacle or the predicted collision risk condition on the road. For example, the AI model may recognize a condition of a track in which a train travels changing from a single track to a double branch track or recognize the obstacle on the track (when the vehicle is the train), track and calculate the speed and direction of a pedestrian or the vehicle in a traveling direction of the vehicle (in the case of vehicle), recognize a risky condition where a collision is predicted, determine that the pattern of the driver behavior does not correspond to a preparatory behavior for track branch or a behavior to cope with a risky condition (e.g., driver's drowsiness, smoking, and looking ahead), and the alarm unit 40 may provide an alarm to the driver.

The processor 60 of the mobile driver assistance device 100 with the AI bidirectional camera according to an embodiment of the present disclosure may receive driving condition information of the vehicle from a control device of the vehicle. For example, the vehicle may be a train, and the processor 60 may receive information about the condition of the train (a driving mode, speed, etc.) from a control device 190 of the train. The AI model of the mobile driver assistance device 100 with the AI bidirectional camera may classify the driver behavior patterns based on the driver image provided by the front camera 20 and recognize a condition of the vehicle (train) track or road from the image provided by the rear camera 30. In addition, the AI model may recognize the information about the adjustment button of the train (a driving mode, speed, etc.) when the vehicle is the train and a condition (the change in the track, etc.) of the vehicle track from the image provided by the rear camera 30, determine whether the pattern of the driver behavior is appropriate, and issue an alarm through the alarm unit 40 when it is determined that the pattern is inappropriate.

In the case of the vehicle, the AI model may track and calculate the direction of a pedestrian or the vehicle from information about the adjustment button of the vehicle and the image provided by the rear camera 30, recognize a risky condition in which a collision is predicted, determine whether the pattern of the driver behavior is appropriate, and issue an alarm through the alarm unit 40 when it is determined that the pattern is inappropriate.

In this case, the alarm unit 40 may issue an alarm through the speaker 42 or the display 50.

In addition, the processor 60 of the mobile driver assistance device 100 with the AI bidirectional camera according to an embodiment of the present disclosure may select a suitable AI model based on a type of the vehicle (a passenger car, train, etc.) input from the driver through the user interface. For example, when the vehicle is a train, the AI model may be a model suitable for track detection (a single track or a double branch track), and when the vehicle is a passenger car, may be a model suitable for road detection (road and center line detection or road junction detection). In addition, the processor 60 may select an AI model that may recognize a change in the track and recognition of an obstacle or a predicted collision risk on the road through the AI model based on the image captured by the front camera 20 or the rear camera 30. In addition, the processor 60 may determine the type of vehicle based on the image captured by the front camera 20 or the rear camera 30 and select an AI model expected based on the determined type of vehicle.

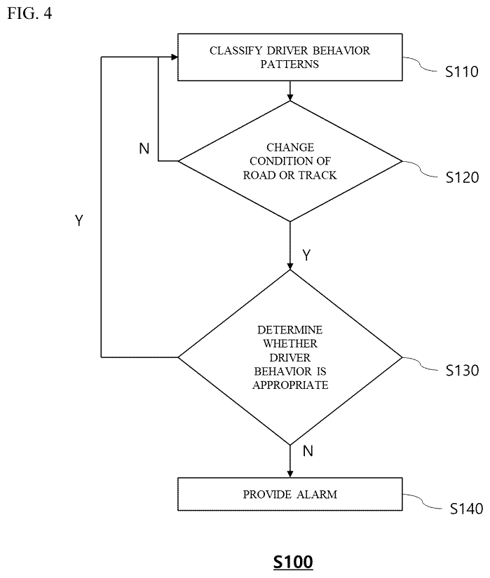

FIG. 4 is a flowchart illustrating a process of performing an AI model according to an embodiment of the present disclosure.

Referring to FIGS. 3 and 4, in a process (S100) of performing an AI model by the processor 60 of the mobile driver assistance device 100 with the AI bidirectional camera according to an embodiment of the present disclosure, the AI model may classify driver behavior patterns by performing image processing on a driver image obtained from the front camera 20 of the vehicle (S110). For example, the driver behavior patterns may be whether to look forward, smoking, drowsiness, absence, etc. In addition, the AI model may perform image processing on an image of a track or road obtained from the rear camera 30 of the vehicle to determine a change in the track, recognition of an obstacle, or a predicted collision risk condition on the road (S120). For example, when the vehicle is a train, in a situation in which a single track is changed to a double branch track, or when the vehicle is a passenger car, in a situation in which a risky condition where a collision is predicted is recognized by tracking and calculating a direction of a pedestrian or the vehicle on the road ahead, the AI model may determine whether a driver behavior is appropriate for the situation (S130). When it is determined that the driver behavior is inappropriate, the processor 60 may provide an alarm to a driver through the alarm unit 40 (S140).

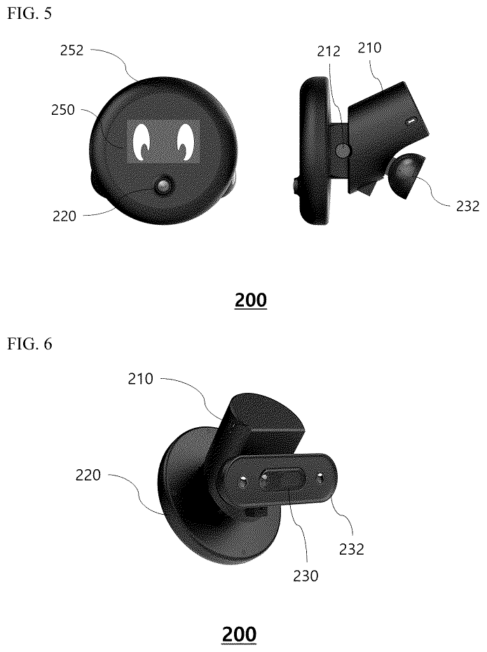

FIG. 5 is a diagram illustrating a front surface and side surfaces of a mobile driver assistance device with an AI bidirectional camera according to another embodiment of the present disclosure. FIG. 6 is a perspective view of the mobile driver assistance device with the AI bidirectional camera according to another embodiment of the present disclosure.

Referring to FIGS. 5 and 6, a mobile driver assistance device 200 with the AI bidirectional camera according to another embodiment of the present disclosure may be attached to the interior of a vehicle, such as a dashboard or a windshield, to display images of the front (a direction looking at a driver) and the rear (a traveling direction of the vehicle or a train).

The mobile driver assistance device 200 may include a front body part 252, a rear body part 232, and a fixing body part 210. The front body part 252, the rear body part 232, and the fixing body part 210 may each be made of, for example, a plastic material, and a processor and a memory may be installed therein. In the same manner as in the embodiment shown in FIG. 2, a front camera 220 may be installed on the front (the direction looking at the driver) of the front body part 252, and a rear camera 230 may be installed on the rear body part 232. Meanwhile, a display 250 may be provided in the front body part 252 to provide alarm information such as a warning to the driver. For example, the display 250 may provide the alarm information to the driver with emoticons such as intuitive (laugh, surprise, and danger warning). In addition, the display 250 may be provided, for example, in the form of a user interface, and may receive information about the vehicle from the driver in a coping state. For example, the driver may input whether the vehicle the driver is driving is a passenger car or a train through the display 50 that is the user interface.

In the present embodiment, at least one of the front body part 252 and the rear body part 232 may be rotatably coupled to the fixing body part 210 with respect to a hinge shaft 212. Accordingly, angles of the front camera 220 and the rear camera 230 may be adjusted according to an installation position inside the vehicle in which the mobile driver assistance device 200 is installed.

Although the present disclosure has been described in relation to the preferred embodiments mentioned above, the scope of the present disclosure is not limited to these embodiments, the scope of the present disclosure is defined by the following claims, and will include various changes and modifications falling within the scope equivalent to the present disclosure.

### EXPLANATION OF REFERENCE NUMERALS

10: body part
20: front camera
30: rear camera
42: speaker
50: display
60: processor
70: memory
80: battery
90: angle adjustment button
120: handle
130: removable fixing means
140: battery charging terminal
150: charging means unit

What is claimed is:

1. A mobile driver assistance device with an artificial intelligence (AI) bidirectional camera installed on a vehicle, the mobile driver assistance device comprising:
a body part;
a front camera installed such that an image capturing lens is exposed to a front of the body part, to capture a driver;
a rear camera installed such that an image capturing lens is exposed to a rear of the body part, to capture a traveling direction of the vehicle;
a processor installed inside the body part and configured to determine, by using an AI model, a behavior of the driver and a condition of a road or a track in front of the vehicle based on images transmitted from the front camera and the rear camera;
a memory installed inside the body part and storing the AI model; and
an alarm unit configured to provide an alarm to the driver according to the determination of the AI model.

2. The mobile driver assistance device of claim 1, wherein the alarm unit includes at least one of a display and a speaker installed on the body part and configured to output sound.

3. The mobile driver assistance device of claim 1, further comprising an angle adjustment button installed to be exposed on the body part and configured to adjust a direction of the front camera or the rear camera.

4. The mobile driver assistance device of claim 1, further comprising:
a handle fixed to a side surface or an upper portion of the body part; and
a support fixing means configured to support or fix the body part to the vehicle.

5. The mobile driver assistance device of claim 1, wherein
a sliding body is provided in an upper front side of the body part,
the front camera is located in a front middle portion of the body part,
the front camera when not in use is covered by the sliding body in a descending state, and
the rear camera is formed at a rear of the sliding body and exposed for use by the sliding body in an ascending state.

6. The mobile driver assistance device of claim 1, wherein the AI model is configured to
classify driver behavior patterns based on a driver image provided by the front camera, recognize the condition of the track or the road of the vehicle from the image provided by the rear camera,
determine whether a pattern of the behavior of the driver is appropriate with reference to condition information of the track or the road acquired from the rear camera, and give an alarm through the alarm unit when it is determined that the pattern is inappropriate.

7. The mobile driver assistance device of claim 6, wherein the AI model is configured to pretrain image data as training data with respect to at least one of traffic light related information, shape information of the track or the road, platform related information, and a collision prediction of a pedestrian or the vehicle so as to recognize the condition of the track or the road.

8. The mobile driver assistance device of claim 7, wherein when the AI model recognizes a condition of the track in which the vehicle travels changing from a single track to a double branch track, a road branch condition, or an obstacle on the road or the track, and determines that the pattern of the behavior of the driver does not correspond to a preparatory behavior for track branch or a behavior to cope with the obstacle, the alarm unit is configured to provide an alarm to the driver.

9. The mobile driver assistance device of claim 8, wherein
the processor is configured to receive driving condition information of the vehicle from a control device of the vehicle, and
the AI model is configured to
classify driver behavior patterns based on a driver image provided by the front camera,
recognize a condition of a vehicle track or the road from the image provided by the rear camera,
determine whether a pattern of the behavior of the driver is appropriate based on the driving condition information of the vehicle and condition information of the track or the road, and issue an alarm through the alarm unit when it is determined that the pattern is inappropriate.

10. The mobile driver assistance device of claim 1, further comprising a user interface capable of receiving a type of the vehicle from the driver,
wherein the processor is configured to select the AI model based on the type of the vehicle.

11. The mobile driver assistance device of claim 1, wherein the processor is configured to determine a type of vehicle based on the image captured by the front camera or the rear camera, and select the AI model based on the determined type of vehicle.
